(19) United States
(12) Patent Application Publication
(10) Pub. No.: US 2023/0027675 A1
(43) Pub. Date: Jan. 26, 2023

(54) BOOSTING SALES PRODUCTIVITY USING PERSONALIZED CONTENT GENERATOR FOR ONLINE SALES

(71) Applicant: EMC IP Holding Company LLC, Hopkinton, MA (US)

(72) Inventors: Amihai Savir, Sansana (IL); Anat Parush Tzur, Beer Sheva (IL); Or Herman-Saffar, Ofakim (IL)

(21) Appl. No.: 17/443,087

(22) Filed: Jul. 20, 2021

(51) Int. Cl. G06Q 30/02; G06Q 30/06; G06F 40/30; G06F 40/10; G06N 5/02

(52) U.S. Cl. CPC G06Q 30/0282; G06F 40/10; G06F 40/30; G06N 5/02; G06Q 30/0627

(57) ABSTRACT

One example method includes generating personalized content for online sales. Recorded calls and other sources are converted to text. The text is semantically processed and correlated with customer data including customer order data to identify content that impacted the purchase of a product. The content may be incorporated into an online product page to facilitate online sales.

### FIELD OF THE INVENTION

Embodiments of the present invention generally relate to electronic commerce and related operations. More particularly, at least some embodiments of the invention relate to systems, hardware, software, computer-readable media, and methods for data driven content generator for improving sales and sales productivity.

### BACKGROUND

Many businesses have a traditional brick and mortar presence for sales while other businesses only have an online presence for sales. Some businesses have both a physical presence and an online presence. In any event, e-commerce is an effective tool to drive sales and revenue and is becoming more and more important to all businesses for various reasons. Customers that purchase online, for example, often spend more. In addition, sales representatives have more time to pursue other sales. These factors may incentivize businesses to help customers move online.

However, e-commerce platforms are not as effective as they should be and there are many reasons that customers purchase offline. For example, some customers want more information or the ability to consult with an expert before making a purchase. This is particularly true when a product is complex or comes in many different configurations.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1 discloses aspects of an insight engine configured to generate insights for improving or boosting online productivity and sales;

FIG. 2 discloses aspects of generating insights and incorporating insights into online product pages;

FIG. 3 discloses additional aspects of generating insights for improving online sales;

FIG. 4 discloses aspects of a method for generating insights for improving online sales; and

FIG. 5 discloses aspects of a computing device or system.

### DETAILED DESCRIPTION OF SOME EXAMPLE EMBODIMENTS

Embodiments of the present invention generally relate to electronic commerce and related operations. More particularly, at least some embodiments of the invention relate to systems, hardware, software, computer-readable media, and methods for performing electronic commerce operations including generating data driven content. Embodiments of the invention use data from, for example offline interactions or data sources to generate content that can be included in an online process. For example, content generated from the data sources may be included in an online product page.

Many entities conduct electronic commerce online (e.g., over the Internet). Embodiments of the invention are configured to migrate customers from offline transactions to online transactions or to electronic commerce. One of the reasons that customers abandon online purchases prior to actually purchasing is the desire to acquire more information about a product or to consult with an expert. Embodiments of the invention are configured to generate content such as by way of example only item descriptions, answers to customer questions, and the like such that customer’s questions can be answered online. This helps an entity conduct and conclude transactions online. This content generated in accordance with embodiments of the invention may be included, for example, on a product page. The content that is generated and included on an online product page can be ordered, prioritized, and the like.

Embodiments of the invention help prevent customers from abandoning the online order process and from purchasing from a competitor. By keeping customers online, sales representatives can work on other tasks or work on the acquisition of new customers.

More specifically, when transactions or customer interactions occur offline, the details that helped close the transaction are not available in the online purchase process. Embodiments of the invention allow data, generated from offline sales, interactions, conversations or the like, to be integrated with and appear on an online product page. This may cause customers to conclude the online order process. Embodiments of the invention allow an entity to develop more personalized or customized product or item descriptions, which is distinct from generic descriptions conventionally appearing in online product pages.

In one example, data such as phone calls between customers and sales representatives, chat transcripts, crowd sourced data is analyzed or processed to obtain insights that can be integrated into online product pages.

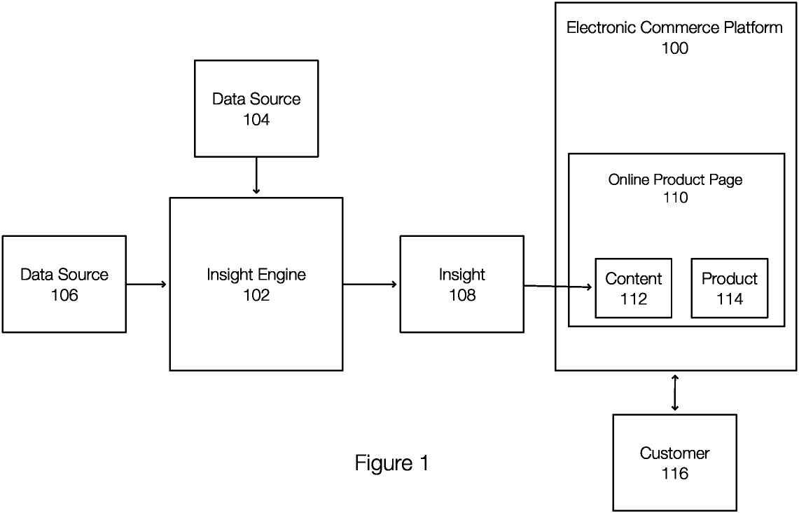

FIG. 1 discloses aspects of a system or architecture for performing electronic commerce and related operations. In FIG. 1, an entity may have an electronic commerce platform 100 that can be accessed by customers (represented by customer 116). The customer 116 can access the electronic commerce platform 100 and browse content provided by the an entity through the platform 100. For example, the platform 100 may provide web pages for its products, support pages, and other types of content that can be accessed online.

In this example, the entity may sell products such as computers and FIG. 1 illustrates an online product page 110 that may be specific to a computer model (represented in this example by the product 114). Thus, the customer 116 is looking at the online product page 110 and potentially deciding whether to purchase the displayed product 114.

Embodiments of the invention relate to an insight engine 102 that is configured to generate insights (represented by insight 108) from data sources 104 and 106. The insight 108 is incorporated into the online product page 110 as content 112. Embodiments of the invention are configured to help improve the likelihood that the customer 116 will purchase the product 114. For example, the insight engine 102 may determine that the insight 108, identified from the data sources 104 and 106 and not currently present in the online product page 110, was a factor in a successful sale.

In one example, the data source 104 may include details related to the customer 116. The details or other information may include historical sales to the customer 116 and other customer-centric data. The data source 106 may include information related to the product 114 that was generated in different settings such as interactions between a customer and a sales representative, crowd-sourced data, chat transcripts, and the like. The insight engine 102 is configured to process data from the data sources 104 and 106 to identify information that may be useful or persuasive to the customer 116 or that may help the customer 116 complete the online transaction.

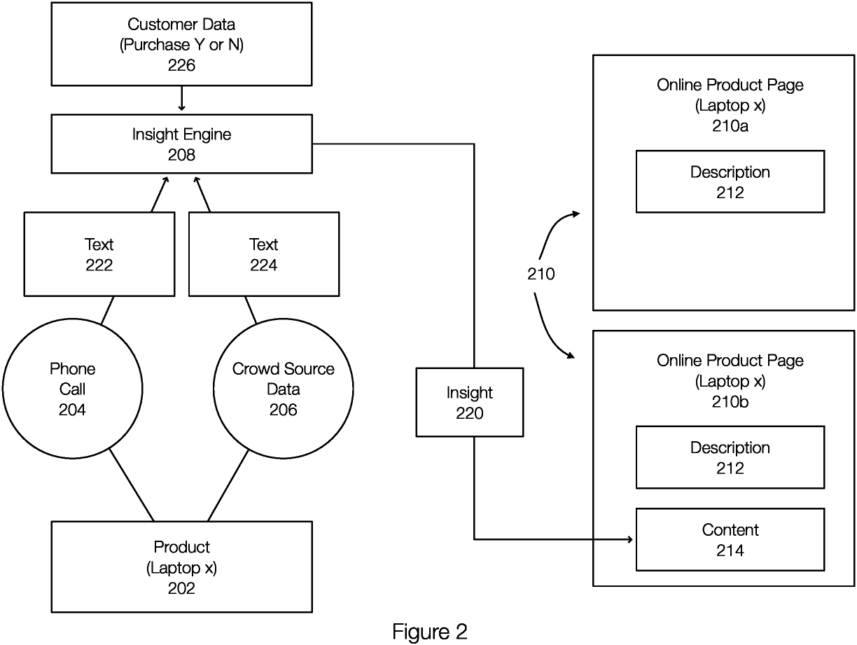

FIG. 2 discloses aspects of an insight engine configured to generate data-driven insights for personalizing content and for improving sales. FIG. 2 illustrates an online product page 210 at two points in time: page 210a prior to insight generation and page 210b after insight generation. The page 210a for a product 202 (e.g., a laptop of model x) may include a description 212. The description 212 may specify or present a description of the product such as screen size, processor speed, number of ports, or the like.

The insight engine 208 may generate an insight 220 that can be integrated into the product’s page, as illustrated in page 210b. In the page 210b, the insight 220 has been incorporated into the page as content 214. The content 214 thus personalizes or customizes the page 210b. The page 210b is a customized and data-driven page.

The insight 220 can be customer dependent. Thus, a customer that logs into the website may be shown certain content 214 while the page 210b may display a different content 214 for an unknown customer. Thus, the insight 220 may be differ based on whether the customer is known or unknown (e.g., new). In either case, the page 210b is more personalized. Stated differently, the insight 220, implemented as content 214, is intended to increase the likelihood that a customer completes the online ordering process for a product 202.

In this example, the insight engine 208 receives data from up to three sources (other sources are may be possible): a phone call 204, crowd source data 206, and customer data 226. More specifically, the phone call 204 may represent a call that occurred with a previous (or current) customer that was recorded. The recorded phone call 204 can be converted to text 222. The text 222 may be representative of a question/answer form, although embodiments of the invention are not limited thereto. For example, the question/answer or text 222 may be: “Can a disk drive be added to the laptop x?”. The answer may be yes in this case. The text of the call may be processed with a natural language processing (e.g., BERT) in order to determine a meaning.

The crowd source data 206 (e.g., a discussion board regarding the laptop x, a board discussing desirable features in a laptop in general) may also be processed to extract text 224. The text 224 may also be in question/answer form. A crowd source data may include comments such as: “Does the laptop x have a disk drive?” or “Laptops should all have a disk drive or space for a disk drive”. The answer included in the crowd source data may be “yes”. This text can be processed semantically to determine meaning by the insight engine 208.

The customer data 226 may indicate, for example, whether a customer purchased the laptop x. In one example, the customer data can be correlated to the text 222 and/or the text 224. For example, if a customer represented by the customer data 226 purchased the laptop x on a day that a customer asked the question represented by the text 222 (“does the laptop x have a disk drive?”), the insight engine 226 may use this information to determine that this information may influence a customer to purchase the produce online.

In other words, the insight engine 208 can ensure that the page 210b includes information that was discussed in an offline (with respect to the online purchase process) manner. The content 214 added to the page 210b may disclose that the laptop x includes a disk drive and allows a disk drive to be added. When a new customer or a current customer sees the content 214, the new customer may purchase the product without having to make inquiries in an offline manner. Thus, the page 210b is personalized or customized to move customers to an online ordering process.

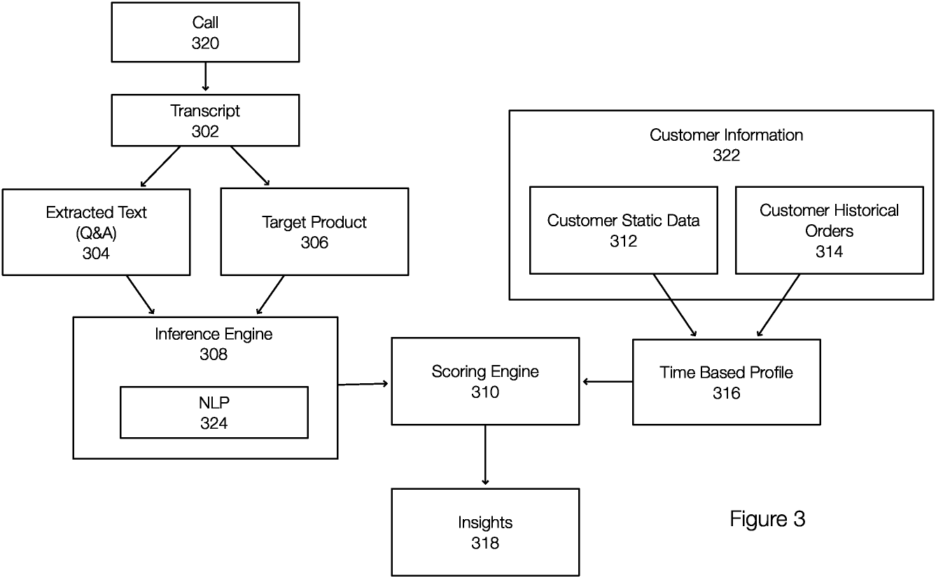

FIG. 3 discloses aspects of a system for integrating insights into online product pages. Initially, the inference engine 308 may analyze a transcript 302 of an audio conversation between a customer and a representative. Thus, the call or audio may have been recorded and the recording was converted to text. The conversion to text may also happen as the call is occurring. In either case, a transcript 302 is available of a call. The transcript 302 is typically associated with a time and date. The transcript 302 may also be segmented such that each segment can be processed separately for semantic meaning.

The inference engine 308 then processes the transcript 302 to generate extracted text 304 and a target product 306. For example, BERT (Bidirectional Encoder Representations from Transformers) can be used to extract the entity or the target product 306 discussed in the call 320. BERT or other extraction engine may also extract text such as question/answer information. The extracted text 304 may include multiple entries.

For example, the extracted text 304 may include the following three questions/answers:
1. Is there a compatible active pen? - Yes
2. Is there a 2 in 1 option? - No
3. Can I add another disk drive? - No

The extracted text 304 and the target produce 306 are provided to the inference engine 308.

The business or entity may also have information regarding the customer, such as customer static data 312 and customer historical orders 314. By correlating the dates of the call 320 with dates of an order included in the customer information 322, the result of the call 320 can be determined. For example, did the customer purchase or not purchase the product.

This further allows a time based profile 316 to be generated. The time based profile 316 may include a timeline of orders, calls, issues with purchased products, or the like. Correlating the time based profile of the customer to the call 320 or more specifically to the extracted text 304 and target product 306 allows the result of the call 320 to be determined. Thus, the inference engine 308 may also have access to the customer information 322.

The scoring engine 310, which may be a component of the inference engine, is configured to score each question/answer or other data extracted from the transcript 302. Using the three questions/answers previously discussed and assuming that the customer purchased the product, question 1 (Is there a compatible active pen?-Yes) is given a higher score and it may be assumed that this aspect of the product was relevant to the customer’s purchase.

The inference engine 308 or the scoring engine 310 may use distancing and semantic similarity to unite similar questions into a single question. For example, the call 320 may include a conversation where a similar question was asked multiple times. Alternatively, the inference engine 308 may have access to multiple transcripts and determine that the same question, even if phrased differently, was asked in many of the corresponding calls.

For example, the transcript of a first call may include the question “Does the laptop have a 4K screen?”. A second transcript of a second call (or another segment of the same call) may include the question “I wonder if this laptop supports 4K resolution?”.

The inference engine 308 may include a natural language processing (NLP) engine such as SPACY (see spacy.io, which is incorporated herein by reference) that may allow the similarity of two documents (e.g., two transcripts or portions thereof) to be determined. In general, the NLP engine 324 can leverage POS (Parts of speech) and semantic meaning to compare, by way of example, two sentences or two questions that may appear in transcripts.

The questions/answers appearing in the transcripts can be sorted based on scores. The scores, in one example, can be a ratio of between the number of occurrences in the transcripts or conversations to the number of transcripts or conversations. This may lead to a prioritized list (e.g., the insights 318) of details that may be added to a product’s page.

For example, the NLP engine 324 may process the transcript and determine that, from a semantic perspective, a first question was asked multiple times (even though phrased differently) and a second question was asked once. This disparity can be represented by a score where the first question (and answer) receives a higher score because it seemed more important to the customer. This may result in an insight that can be incorporated into a product page.

Embodiments of the invention may be performed periodically and a knowledge graph of frequently questioned answers (FQA) may be developed and maintained. In addition, this may give insight about other products. For example, a customer may want to know the main distinction between laptop A and laptop B. As a result, information from a call focusing on a first product may also be relevant to another product and/or to product development in general. The most relevant details could be added to a product’s page.

Embodiments of the invention can improve the customer experience, for example, by personalizing or customizing the product’s page. Embodiments of the invention correlation customer questions/answers with a conversion rate (convert the inquiry to an order).

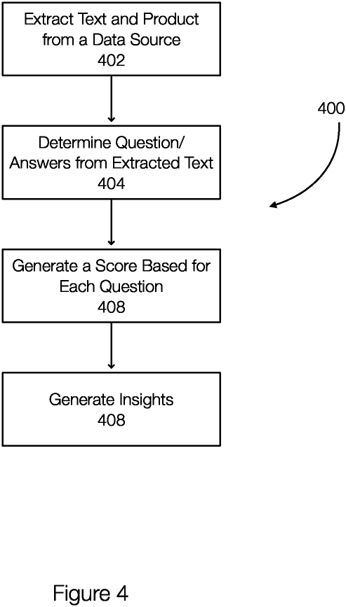

FIG. 4 discloses aspects of a method for generating insights. Embodiments of the invention are disclosed in the context of generating insights based on questions asked by customers that were not answered in the online product page. Thus, embodiments of the invention may process the recorded call data with the purpose of extracting questions/answers with a goal of improving sales. Embodiments of the invention, however, can be adapted to other scenarios in which the text is processed for other purposes that may have a format different from question/answer.

The method 400 begins by extracting 402 text and/or product identification from a data source. In one example, the data source may be a recorded phone call, a chat transcript, crowd-source data, or the like. In one example, the method 400 may include generating the data source such as be recording the phone call or the like.

Next, the data source is processed to determine information such as question/answer and/or product. An NLP engine may be used to semantically process the extracted text. In one example, the text may be processed to add punctuation, segmented or the like. This allows the NLP engine to process, by way of example, segments such as sentences. This further allows the segments to be semantically compared such that questions asked in different ways are identified as the same question asked multiple times. These questions can be associated with answers and with a specific product.

A score is generated 408 for each question. The score may be based on the number of times a question is asked compared to the number of times other questions are asked, a ratio of the question to number of transcripts, or the like.

Content or insights are generated 408 from the highest scoring questions/answers and may be included in the online product page.

Embodiments of the invention can leverage customer questions to inform the development of product pages or the e-commerce platform. Further, questions and answers from recorded phone calls or other sources can be correlated to actual sales. Further a knowledge graph may be generated and retained to understand what data has the best impact on sales.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

The following is a discussion of aspects of example operating environments for various embodiments of the invention. This discussion is not intended to limit the scope of the invention, or the applicability of the embodiments, in any way.

New and/or modified data collected and/or generated in connection with some embodiments, may be stored in a data protection environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to service read, write, delete, backup, restore, and/or cloning, operations initiated by one or more clients or other elements of the operating environment.

Example cloud computing environments, which may or may not be public, include storage environments that may provide data protection functionality for one or more clients. Another example of a cloud computing environment is one in which processing, data protection, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, or virtual machines (VM) or containers.

As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

It is noted that any of the disclosed processes, operations, methods, and/or any portion of any of these, may be performed in response to, as a result of, and/or, based upon, the performance of any preceding process(es), methods, and/or, operations. Correspondingly, performance of one or more processes, for example, may be a predicate or trigger to subsequent performance of one or more additional processes, operations, and/or methods. Thus, for example, the various processes that may make up a method may be linked together or otherwise associated with each other by way of relations such as the examples just noted. Finally, and while it is not required, the individual processes that make up the various example methods disclosed herein are, in some embodiments, performed in the specific sequence recited in those examples. In other embodiments, the individual processes that make up a disclosed method may be performed in a sequence other than the specific sequence recited.

Following are some further example embodiments of the invention. These are presented only by way of example and are not intended to limit the scope of the invention in any way.

Embodiment 1. A method, comprising: semantically extracting data from text obtained from a data source, wherein the extracted data from the data source includes questions, answers, and a product, generating a score for each question and answer, generating an insight for the product based on the score, and incorporating the insight into an online product page of the product.

Embodiment 2. The method of embodiment 1, further comprising converting the data source to the extracted data, the extracted data including text.

Embodiment 3. The method of embodiment 1 and/or 2, further comprising segmenting the text into segments and determining questions and associated answers from the segments.

Embodiment 4. The method of embodiment 1, 2, and/or 3, further comprising determining a number of semantically equivalent questions included in the text.

Embodiment 5. The method of embodiment 1, 2, 3, and/or 4, further comprising generating the score based on the number of semantically equivalent questions compared to a number of data sources including the data source.

Embodiment 6. The method of embodiment 1, 2, 3, 4, and/or 5, wherein at least some of the data sources comprise a transcript of a recorded call.

Embodiment 7. The method of embodiment 1, 2, 3, 4, 5, and/or 6, wherein at least some of the data sources include crowd sourced data.

Embodiment 8. The method of embodiment 1, 2, 3, 4, 5, 6, and/or 7, further comprising generating a knowledge graph to relate the insight to other products.

Embodiment 9. The method of embodiment 1, 2, 3, 4, 5, 6, 7, and/or 8, further comprising comparing the data source to with orders in order to correlate the questions and the answers with a purchase of the product or a non-purchase of the product.

Embodiment 10. The method of embodiment 1, 2, 3, 4, 5, 6, 7, 8, and/or 9, further comprising generating the score of the questions and the answers based on whether the product was purchased.

Embodiment 11. A method for performing any of the operations, methods, or processes, or any portion of any of these or combination thereof, disclosed herein and or in embodiments 1-10.

Embodiment 12. A non-transitory storage medium having stored therein instructions that are executable by one or more hardware processors to perform operations comprising the operations of any one or more of embodiments 1-11.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

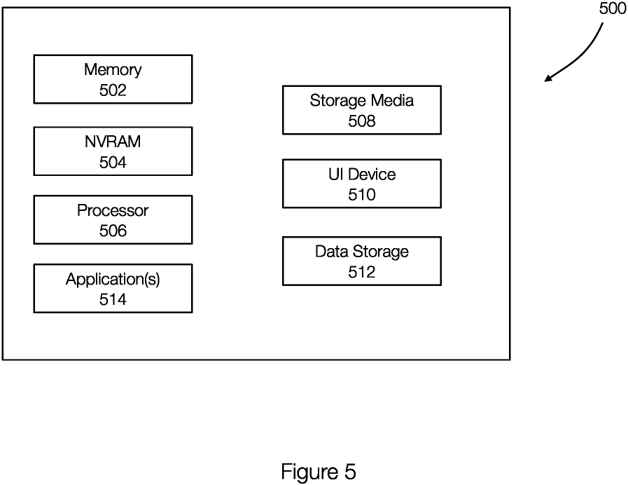

With reference briefly now to FIG. 5, any one or more of the entities disclosed, or implied, by the Figures and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 5.

In the example of FIG. 5, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 500 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
semantically extracting data from text obtained from a data source, wherein the extracted data from the data source includes questions, answers, and a product;
generating a score for each question and answer;
generating an insight for the product based on the score; and
incorporating the insight into an online product page of the product.

2. The method of claim 1, further comprising converting the data source to the extracted data, the extracted data including text.

3. The method of claim 2, further comprising segmenting the text into segments and determining questions and associated answers from the segments.

4. The method of claim 3, further comprising determining a number of semantically equivalent questions included in the text.

5. The method of claim 4, further comprising generating the score based on the number of semantically equivalent questions compared to a number of data sources including the data source.

6. The method of claim 5, wherein at least some of the data sources comprise a transcript of a recorded call.

7. The method of claim 4, wherein at least some of the data sources include crowd sourced data.

8. The method of claim 1, further comprising generating a knowledge graph to relate the insight to other products.

9. The method of claim 1, further comprising comparing the data source to with orders in order to correlate the questions and the answers with a purchase of the product or a non-purchase of the product.

10. The method of claim 9, further comprising generating the score of the questions and the answers based on whether the product was purchased.

11. A non-transitory storage medium having stored therein instructions that are executable by one or more hardware processors to perform operations comprising:
semantically extracting data from text obtained from a data source, wherein the extracted data from the data source includes questions, answers, and a product;
generating a score for each question and answer;
generating an insight for the product based on the score; and
incorporating the insight into an online product page of the product.

12. The method of claim 1, further comprising converting the data source to the extracted data, the extracted data including text.

13. The method of claim 2, further comprising segmenting the text into segments and determining questions and associated answers from the segments.

14. The method of claim 3, further comprising determining a number of semantically equivalent questions included in the text.

15. The method of claim 4, further comprising generating the score based on the number of semantically equivalent questions compared to a number of data sources including the data source.

16. The method of claim 5, wherein at least some of the data sources comprise a transcript of a recorded call.

17. The method of claim 4, wherein at least some of the data sources include crowd sourced data.

18. The method of claim 1, further comprising generating a knowledge graph to relate the insight to other products.

19. The method of claim 1, further comprising comparing the data source to with orders in order to correlate the questions and the answers with a purchase of the product or a non-purchase of the product.

20. The method of claim 9, further comprising generating the score of the questions and the answers based on whether the product was purchased.
